(19) United States
(12) Patent Application Publication
(10) Pub. No.: US 2019/0354607 A1
(43) Pub. Date: Nov. 21, 2019

(54) Personal Blockchain Services

(71) Applicant: Factom, Austin, TX (US)

(72) Inventor: Paul Snow, Austin, TX (US)

(73) Assignee: Factom, Austin, TX (US)

(21) Appl. No.: 15/983,632

(22) Filed: May 18, 2018

(51) Int. Cl. G06F 17/30; H04L 9/06; G06Q 20/38

(52) U.S. Cl. CPC G06F 17/30185; H04L 9/0643; H04L 2209/56; G06Q 20/382; H04L 2209/38; G06F 17/30283

(57) ABSTRACT

A personal blockchain is generated as a cloud-based software service in a blockchain environment. The personal blockchain immutably archives particular usage of any device, perhaps as requested by a user. The user may thus peruse past or historical usage (such as message logs) and individually select historical messages that are desired for a blockchain recordation in the personal blockchain. Moreover, the usage may be publicly ledgered by still other blockchains, thus providing two-way ledgering for improved record keeping.

### CROSS-REFERENCE TO RELATED APPLICATIONS

This application relates to U.S. application Ser. No. ______ filed May 18, 2018, entitled “Private Cryptocoinage in Blockchain Environments” (Attorney Docket Factom #10), and incorporated herein by reference in its entirety. This application also relates to U.S. application Ser. No. ______ filed May 18, 2018, entitled “Load Balancing in Blockchain Environments” (Attorney Docket Factom #11), and incorporated herein by reference in its entirety. This application also relates to U.S. application Ser. No. ______ filed May 18, 2018, entitled “Import and Export in Blockchain Environments” (Attorney Docket Factom #12), and incorporated herein by reference in its entirety. This application also relates to U.S. application Ser. No. ______ filed May 18, 2018, entitled “Private Blockchain Services” (Attorney Docket Factom #14), and incorporated herein by reference in its entirety.

### BACKGROUND

Blockchain usage is growing. As cryptographic blockchain gains acceptance, improved techniques are needed to provide personal record keeping.

### BRIEF DESCRIPTION OF THE SEVERAL VIEWS OF THE DRAWINGS

The features, aspects, and advantages of the exemplary embodiments are understood when the following Detailed Description is read with reference to the accompanying drawings, wherein:

FIGS. 1-15 are simplified illustrations of a personal blockchain environment, according to exemplary embodiments;

FIGS. 16-20 are more detailed illustrations of an operating environment, according to exemplary embodiments;

FIGS. 21-25 illustrate a blockchain data layer, according to exemplary embodiments;

FIGS. 26-27 illustrate identifier mechanisms, according to exemplary embodiments;

FIG. 28 further illustrates the blockchain data layer, according to exemplary embodiments;

FIG. 29 illustrates a cryptocurrency micro-payment, according to exemplary embodiments

FIGS. 30-31 illustrate web access, according to exemplary embodiments;

FIGS. 32-33 are flowcharts illustrating a method or algorithm for service processing, according to exemplary embodiments; and

FIGS. 34-35 depict still more operating environments for additional aspects of the exemplary embodiments.

### DETAILED DESCRIPTION

The exemplary embodiments will now be described more fully hereinafter with reference to the accompanying drawings. The exemplary embodiments may, however, be embodied in many different forms and should not be construed as limited to the embodiments set forth herein. These embodiments are provided so that this disclosure will be thorough and complete and will fully convey the exemplary embodiments to those of ordinary skill in the art. Moreover, all statements herein reciting embodiments, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating the exemplary embodiments. The functions of the various elements shown in the figures may be provided through the use of dedicated hardware as well as hardware capable of executing associated software. Those of ordinary skill in the art further understand that the exemplary hardware, software, processes, methods, and/or operating systems described herein are for illustrative purposes and, thus, are not intended to be limited to any particular named manufacturer.

As used herein, the singular forms “a,” “an,” and “the” are intended to include the plural forms as well, unless expressly stated otherwise. It will be further understood that the terms “includes,” “comprises,” “including,” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that when an element is referred to as being “connected” or “coupled” to another element, it can be directly connected or coupled to the other element or intervening elements may be present. Furthermore, “connected” or “coupled” as used herein may include wirelessly connected or coupled. As used herein, the term “and/or” includes any and all combinations of one or more of the associated listed items.

It will also be understood that, although the terms first, second, etc. may be used herein to describe various elements, these elements should not be limited by these terms. These terms are only used to distinguish one element from another. For example, a first device could be termed a second device, and, similarly, a second device could be termed a first device without departing from the teachings of the disclosure.

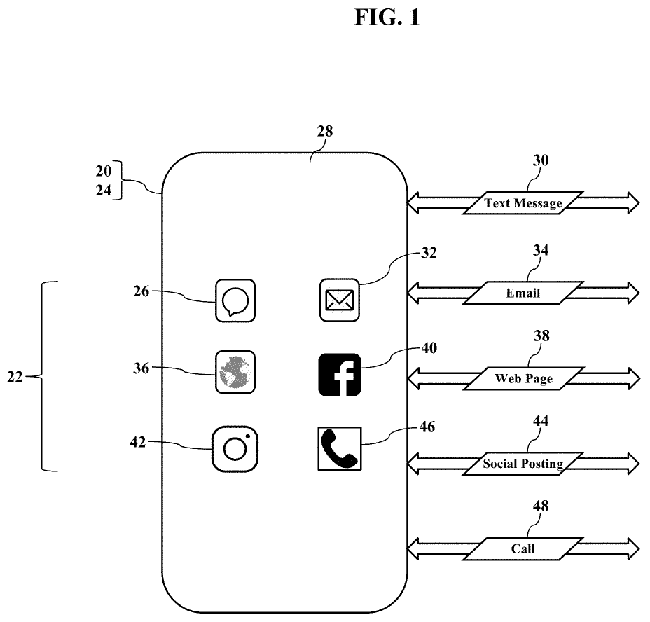

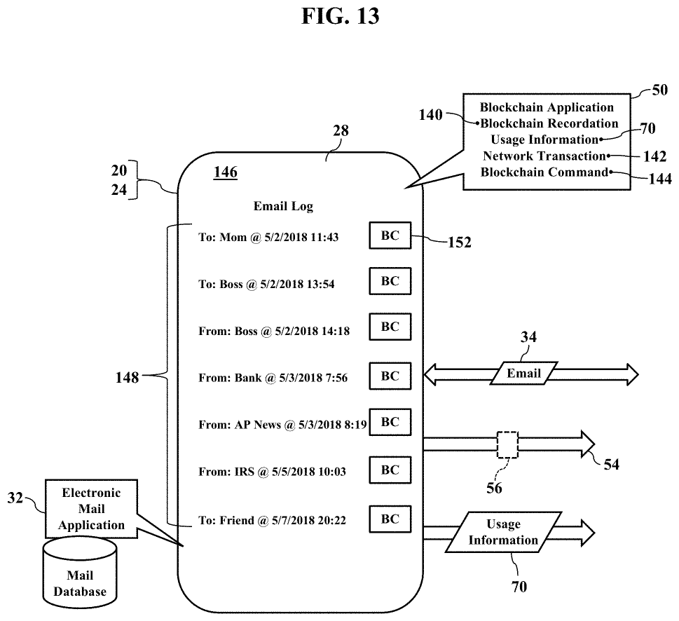

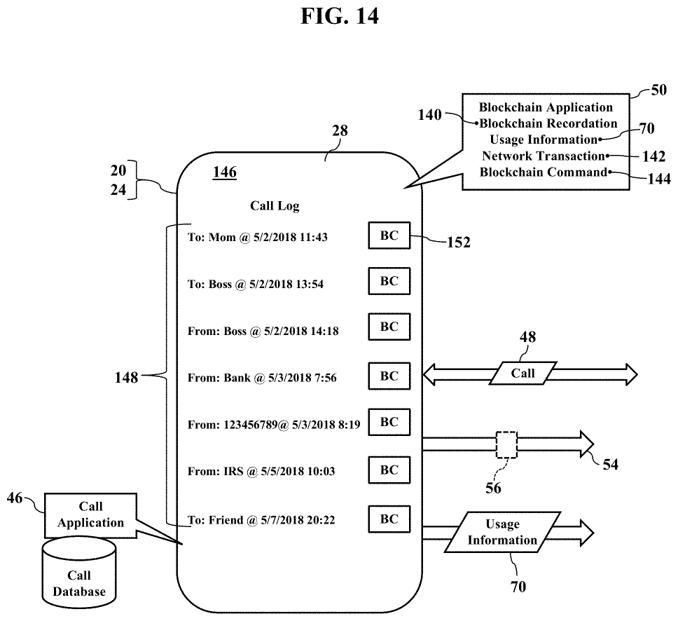

FIGS. 1-15 are simplified illustrations of an operating environment, according to exemplary embodiments. A device 20 downloads, stores, and executes various software applications 22. While the device 20 may be any processor-controlled system, most readers are familiar with mobile computing. FIG. 1 thus illustrates the device 20 as a mobile smartphone 24, which many people use and carry. As the smartphone 24 operates, the smartphone 24 executes any of the software applications 22 to provide functions and services. For example, a messaging application (illustrated by a messaging icon 26 displayed by a display device 28) allows the smartphone 24 to send and receive text messages 30. An electronic mail application (illustrated by a mail icon 32) instructs the smartphone 24 to send and receive electronic mail 34. A web browser application (illustrated by a browser icon 36) allows the smartphone 24 to access the Internet and download web pages 38. Various other software applications 22 (such as FACEBOOK® and INSTAGRAM® icons 40 and 42) access social networking sites and upload/download social postings 44. A call application (illustrated by a call icon 46) causes the smartphone 24 to place/send and receive voice-over and telephony calls 48. These software applications 22 are merely some of the most common functions and services.

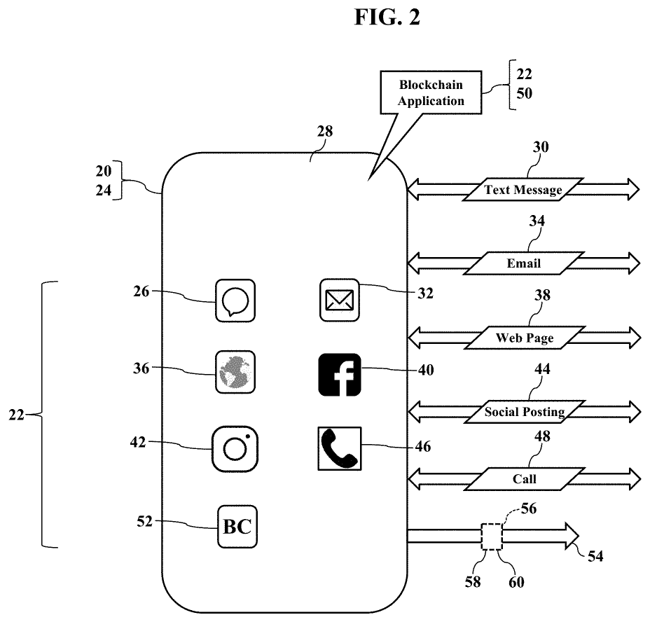

FIG. 2 documents this usage. However the smartphone 24 is used, exemplary embodiments provide immutable proof or evidence of usage. Another one of the software applications 22 is a blockchain application 50 (perhaps represented by “BC” icon 52). As the smartphone 24 is used, the blockchain application 50 may record any usage in a personal blockchain 54. For example, the blockchain application 50 may cause the smartphone 24 to integrate any sent or received text message 30 as a block 56 of data within the personal blockchain 54. Similarly, any electronic mail 34 that is sent or received may be represented in one of the blocks 56 of data within the personal blockchain 54. Any web page 38, social posting 44, and call 48 may also be represented within the personal blockchain 54. Indeed, any usage of the smartphone 24, and/or any usage of any software application 22, may be documented within the personal blockchain 54. Moreover, exemplary embodiments may also integrate a date/time stamp 58 (e.g., date and time) and a current location 60 (e.g., GPS), thus further pinpointing any usage within the personal blockchain 54. The personal blockchain 54 thus acts or functions as a personal or private storage and evidentiary repository or archive for any usage of the smartphone 24.

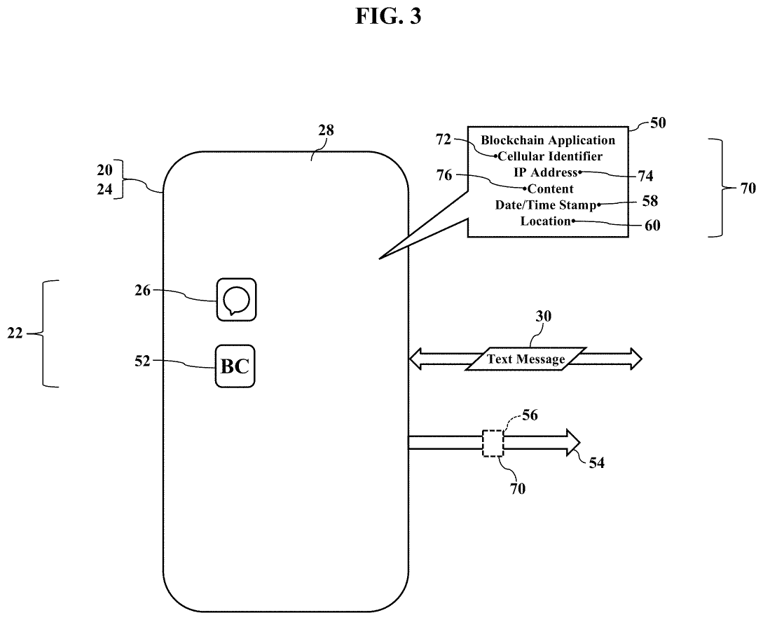

FIG. 3 illustrates a simple example. Many readers have used the smartphone 24 to send the electronic text message 30. When the user sends the text message 30, exemplary embodiments gather usage information 70. While the usage information 70 may be any electronic data or representation, the usage information 70 is likely binary data or values that particularly describe the text message 30. For example, the usage information 70 may include a sender's and/or a receiver's cellular identifier 72 and/or Internet protocol address 74. If the text message 30 has multiple recipients (such as a group distribution or TWITTER® account), then the usage information 70 may include any data representing multiple recipients. The usage information 70 may include data representing the content 76 of the text message 30, and the content 76 may include textual data, image data, video data, emoji content, and any other information. Moreover, the usage information 70 may also include the date/time stamp 58 and the location 60 (such as GPS information). The blockchain application 50 may independently collect the usage information 70, or the blockchain application 50 may interface with, and/or cooperate with, the messaging application (illustrated by the messaging icon 26) to gather the usage information 70. Regardless, the blockchain application 50 may then generate the personal blockchain 54 that incorporates or represents the usage information 70. The personal blockchain 54 thus contains the block 56 of data that immutably records the date, time, content 76, and the location 60 of the text message 30.

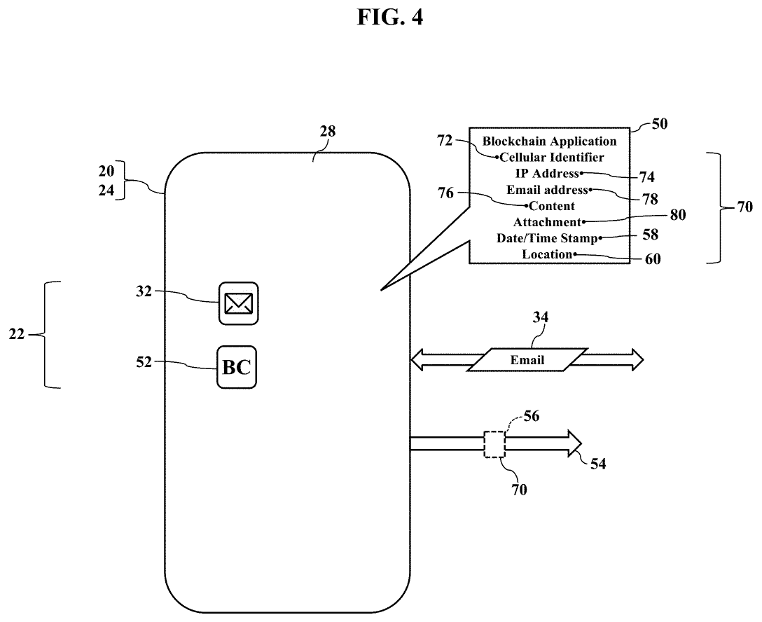

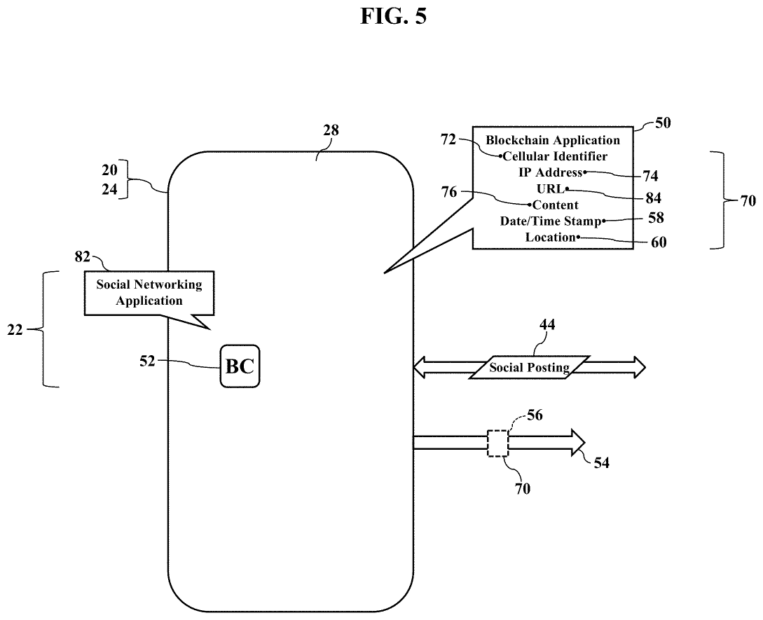

FIGS. 4-5 illustrate more examples. FIG. 4 illustrates documentation of the email message 34. When the user composes and sends the email message 34, here again exemplary embodiments obtain the usage information 70 and may generate the block 56 of data in the personal blockchain 54 that represents the email message 34. The usage information 70 may include the sender's and the receiver's cellular identifiers 72, IP addresses 74, and/or email addresses 78. The usage information 70 may include data representing the textual, video, and/or image content 76. The usage information 70 may also include data representing any email attachment 80 (such as a filename and/or byte count or file size). The usage information 70 may also include the date/time stamp 58 and GPS information representing the location 60. The blockchain application 50 may then send the block 56 of data and/or the personal blockchain 54 to any destination, as later paragraphs will explain.

FIG. 5 illustrates the social posting 44. Here the blockchain application 50 may preserve proof of the social posting 44 to FACEBOOK®, INSTAGRAM®, or other social networking site. The user invokes a social networking application 82 to compose and send/post her social posting 44 as an electronic message. Exemplary embodiments obtain the usage information 70 and may then generate the block 56 of data in the personal blockchain 54. The usage information 70 may include the sender's cellular identifier 72 and/or the IP address 74 and a receiver's IP address or destination uniform resource locator (“URL”) 84. The usage information 70 may include data representing the textual, video, and/or image content 76, the date/time stamp 58, and GPS information representing the location 60. The blockchain application 50 may then send the block 56 of data and/or the personal blockchain 54 to any destination, as later paragraphs will explain.

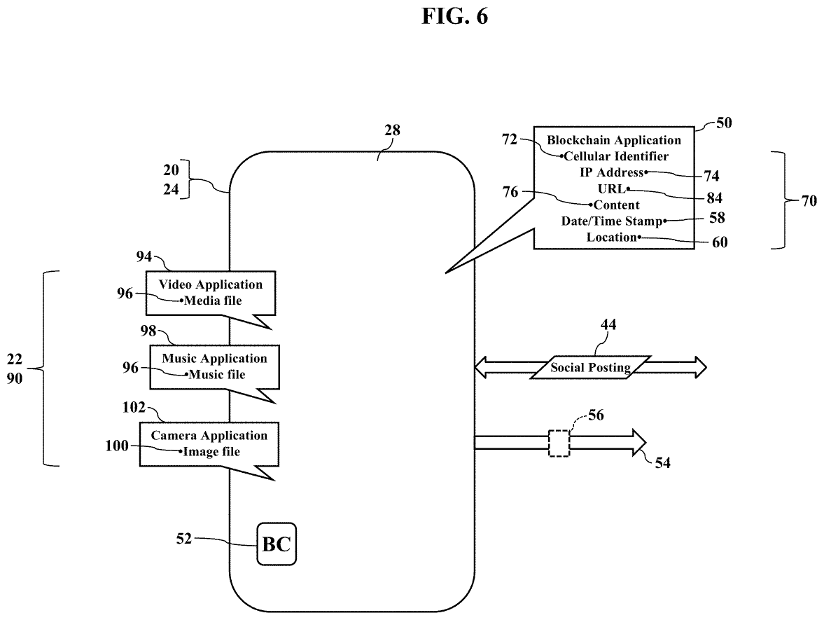

FIG. 6 illustrates other digital assets. Here the user's personal blockchain 54 may document any electronic or digital content 90 stored by, or accessed by, the smartphone 24. Again, as the reader likely understands, the smartphone 24 may stream, download, store, and/or play a digital movie or media 92 (perhaps by executing a video application 94) and a digital music 96 (perhaps by executing a music application 98). The smartphone 24 may also capture and store a digital image 100 using a camera application 102 (and a digital camera, not shown for simplicity). Whatever the digital asset 90, the blockchain application 50 may retrieve its corresponding usage information 70 (e.g., cellular identifier 72, IP address 74, the date/time stamp 58, the URL 84, the location 60, and data representing a title, description, and/or the content 76). Exemplary embodiments may then generate the block 56 of data in the personal blockchain 54. When the smartphone 24 requests, downloads, and/or receives the digital asset 90, exemplary embodiments may document that usage in the personal blockchain 54. Each time the smartphone 24 retrieves and/or plays back the digital asset 90, exemplary embodiments may retrieve the corresponding usage information 70 (e.g., the date/time stamp 58 of playback, the location 60, and textual description) and generate another block 56 of data in the personal blockchain 54. Moreover, should the smartphone 24 pause playback, the blockchain application 50 may retrieve the corresponding usage information 70 (e.g., the date/time stamp 58 and location 60 of pausing) and generate another block 56 of data in the personal blockchain 54. When the smartphone 24 later resumes play, the blockchain application 50 may retrieve the corresponding usage information 70 (e.g., the date/time stamp 58 and location 60 of resumption) and generate another block 56 of data in the personal blockchain 54. The user's personal blockchain 54 may thus privately document each complete or partial consumption of the digital asset 90.

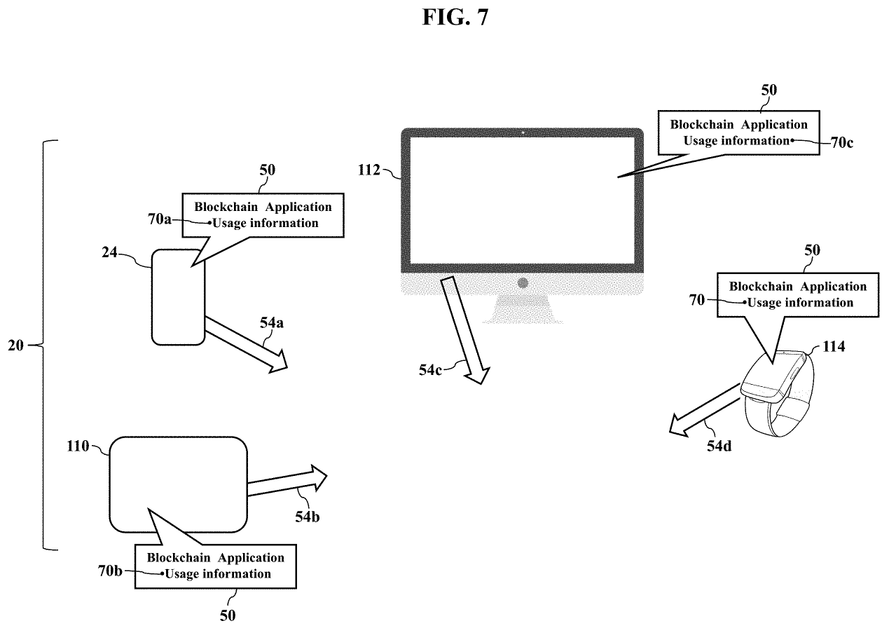

FIG. 7 illustrates device-specific implementations. As the reader likely understands, the user may have multiple devices 20. That is, suppose the user has the smartphone 24, a tablet computer 110 (such as an APPLE IPAD®), perhaps a desktop computer 112, and perhaps even a smartwatch 114. Whatever the device 20, exemplary embodiments may document any usage of either one of the multiple devices 20. Each one of the devices 20 may individually download, locally store, and execute the blockchain application 50. Each one of the devices 20, in other words, may locally generate a device-specific, personal blockchain 54a-d that documents the usage of the corresponding device 20. For example, the blockchain application 50 (locally operating in the smartphone 24) collects its corresponding usage information 70a and generates the personal blockchain 54a representing the usage of the smartphone 24.

The user's other devices 20 may generate their own, individual blockchains. For example, any time the tablet computer 110 is used, its locally-stored blockchain application 50 collects the corresponding usage information 70b and generates the personal blockchain 54b that is dedicated to or represents the tablet computer 110. The personal blockchain 54b thus immutably documents any usage information 70b received by, generated by, and/or transmitted by the tablet computer 110. Similarly, whenever the desktop computer 112 and the smartwatch 114 operate, the locally-stored blockchain applications 50c-d collects the corresponding usage information 70c-d and generates entries in the personal blockchains 54c-d that is specific, respectively, to the desktop computer 112 and to the smartwatch 114. The personal blockchains 54c-d thus immutably document any device-specific usage information 70c-d received by, generated by, and/or transmitted by the desktop computer 112 and the smartwatch 114.

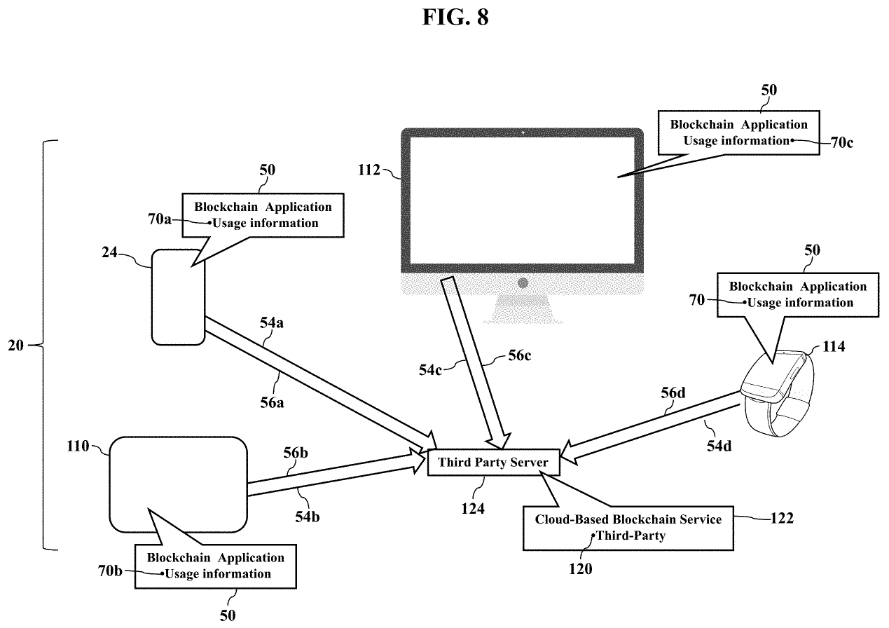

FIG. 8 illustrates centralized collection. Here the user's multiple devices 20 may export their respective device-specific, personal blockchains 54a-d to a common network destination. Because each of the user's devices 20 may generate its own, personal blockchain 54a-d, the common user may wish to utilize a third-party 120 to manage all her personal blockchains 54a-d. The third-party 120, for example, offers an online, cloud-based blockchain service 122 that offers the blockchain application 50 for download to customers/subscribers as a service provider. Each one of the user's multiple devices 20 may thus send their respective device-specific, personal blockchains 54a-d to a network address (e.g., IP address) associated with the third-party 120 (such as a third-party server 124). When the third-party server 124 receives any blocks 56a-d of data associated with any of the device-specific, personal blockchains 54a-d, the third-party server 124 may then provide the cloud-based blockchain service 122. The cloud-based blockchain service 122, for example, may publicly document any of the device-specific, personal blockchains 54a-d. So, even though the user's devices 20 may generate multiple, personal blockchains 54a-d, the cloud-based blockchain service 122 ensures that even the private, personal blockchains 54a-d are publicly published for inspection and verification (which later paragraphs will explain). The cloud-based blockchain service 122 thus acts as a public ledger that establishes chains of blocks of immutable evidence.

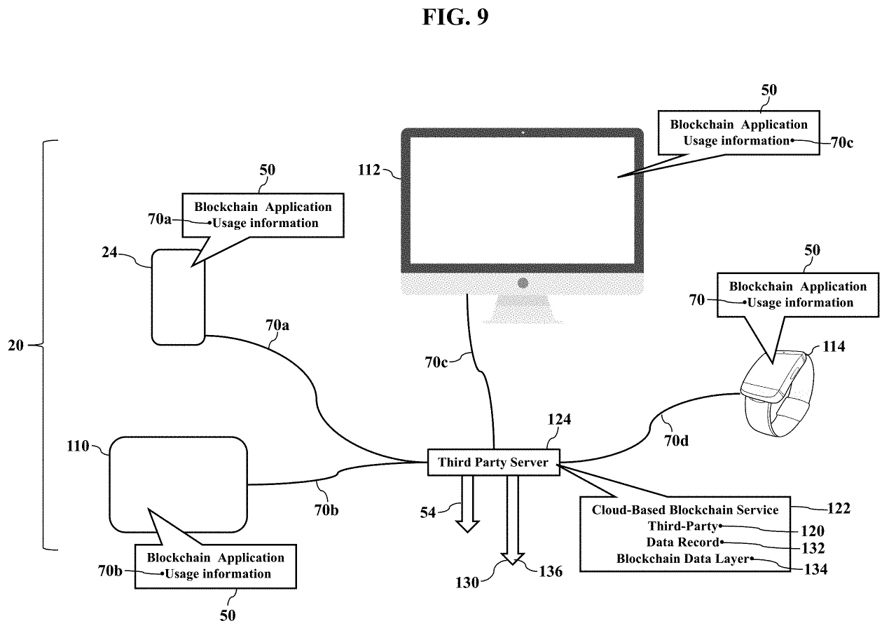

FIG. 9 also illustrates centralized collection. Here, though, exemplary embodiments may send or push the usage information 70a-d to the cloud-based blockchain service 122. When any blockchain application 50, executed by any of the user's devices 20, obtains the usage information 70, here exemplary embodiments may send the usage information 70 directly to the third-party server 124. The cloud-based blockchain service 122 may then generate the personal blockchain 54. The personal blockchain 54, in other words, is specific to the user and is dedicated to documenting usage of all the user's multiple devices 20. The cloud-based blockchain service 122 thus collects any or all of the usage information 70a-d generated by any of the user's devices 20. The usage information 70a-d may then be incorporated as data records in the user-specific personal blockchain 54. The user-specific personal blockchain 54 may be private and not available for public inspection.

As FIG. 9 also illustrates, the cloud-based blockchain service 122 may have a public option. Any or all of the usage information 70a-d may be publicly published via a public blockchain 130. The third-party server 124, for example, may generate data records 132 in a blockchain data layer 134, as later paragraphs will explain. Moreover, the third-party server 124 may also add an additional layer of cryptographic hashing to generate one or more cryptographic proofs 136. The cryptographic proofs 136 may then be incorporated into the public blockchain 130. The cloud-based blockchain service 122 may then publicly publish or distribute the public blockchain 130 (such as via the Internet). The public blockchain 130 thus serves or acts as a validation of the cloud-based blockchain service 122 (perhaps described by the data records 132 within the blockchain data layer 134). The public blockchain 130 thus publishes the cryptographic proofs 136 to confirm that the usage information 70a-d was converted into, or integrated into, the user-specific personal blockchain 54 and/or into the public blockchain 130. The cryptographic proof 136, in other words, acts as a data anchor in the public blockchain 130 to document the date and time that the cloud-based blockchain service 122 was executed. The public blockchain 130 thus acts as a public ledger that establishes chains of blocks of immutable evidence. Each cryptographic proof 136 thus provides evidentiary documentation of the cloud-based blockchain service 122.

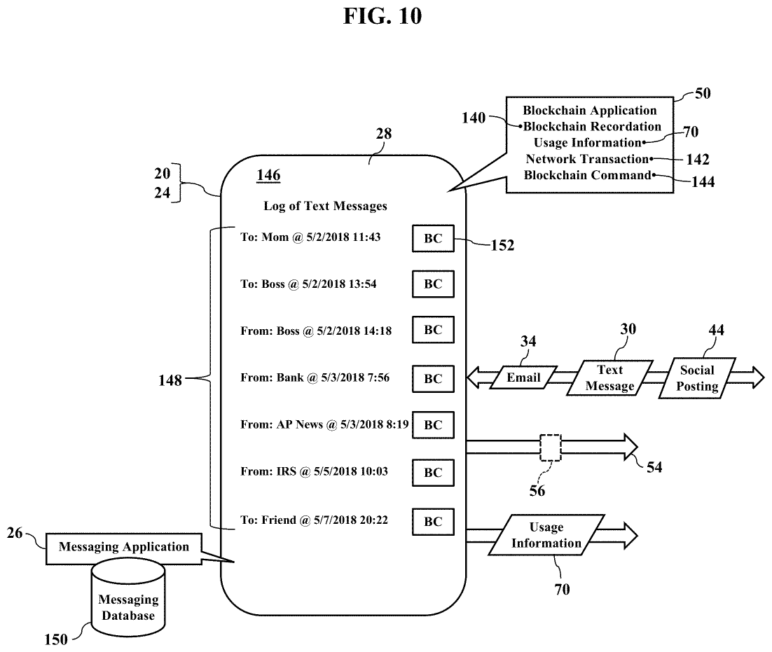

FIG. 10 illustrates transactional mechanisms. The above paragraphs explain how any usage of the devices 20 may be immutably evidence using blockchain technology. As the reader may understand, though, not all usage is worthy of blockchain documentation. For example, some emails 34, text messages 30, and social postings 44 represent trivial matters that have little financial value or importance (especially if the cloud-based blockchain service 122 imposes financial charges and/or storage limits). The user, then, may wish to conserve resources (e.g., time and/or money) and only blockchain important messages, topics, or usage.

FIG. 10 thus illustrates a blockchain recordation 140. When the user wishes to document any usage information 70 and/or any network transaction 142 (such as a send/receipt of the SMS text message 30, email 34, web page 38, and social posting 44), the user issues, enters, or inputs a blockchain command 144. While exemplary embodiments may utilize any mechanism for providing or generating the blockchain command 144, most readers are familiar with graphical representation. The blockchain application 50, for example, may cause the smartphone 24 to generate a graphical user interface 146 that displays a list 148 of the text messages 30. Exemplary embodiments may interface with, or cooperate with, the messaging application 26 to query a messaging database 150. The messaging database 150 is a local or remote resource that stores or logs historical text messages 30 associated with the smartphone 24. Exemplary embodiments may thus retrieve any usage information 70 describing any text message 30 sent from, or received by, the smartphone 24. Exemplary embodiments may then display or present the blockchain command 144 as a graphical icon 152 for selection via the touch-screen display device 28. The blockchain command 144 may thus be a graphical control that is generated and displayed for invoking the blockchain recordation 140 of an individual one or more of the text messages 30. When the user wishes to blockchain any text message 30 in the list 148, the user need only input the corresponding blockchain command 144 (such as touching the capacitive pixels associated with the graphical icon 152). The blockchain application 50 may then collect the usage information 70 associated with the text message 30 selected for the blockchain recordation 140 (perhaps as stored in the messaging database 150). The blockchain application 50 may then blockchain the selected text message(s) 30, as above explained.

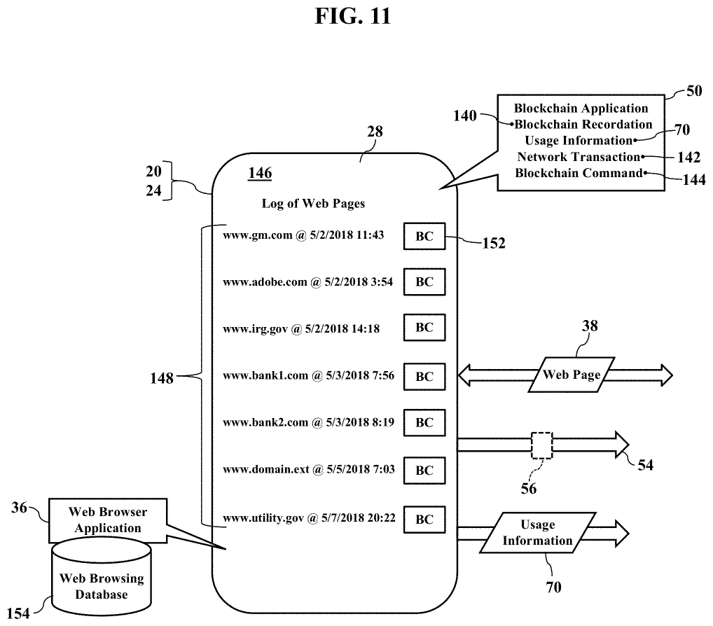

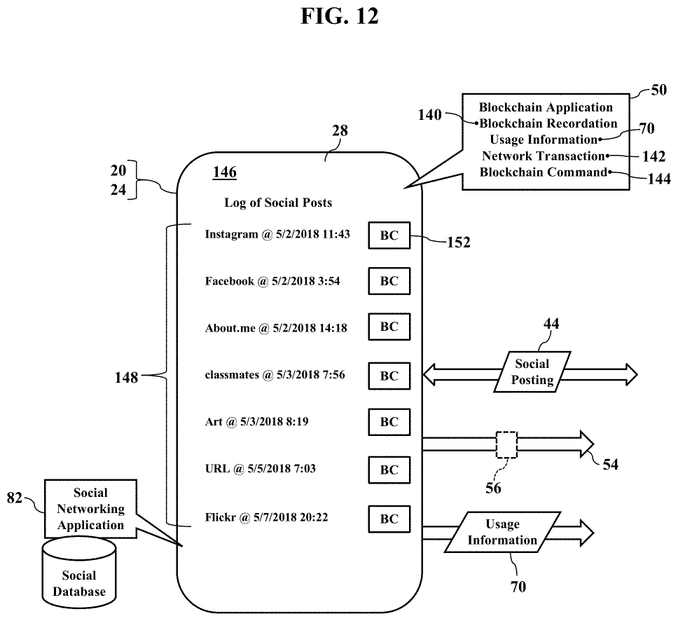

FIGS. 11-14 illustrate other blockchain recordations 140. FIG. 11, for example, illustrates the blockchain recordation 140 of any historical browsing behavior. The blockchain application 50 may interface with the web browser application 36 to query a web browsing database 154 that locally or remotely stores historical requests for the web pages 38 associated with the smartphone 24. The graphical user interface 146 may then be tailored to present historical web pages 38 requested or downloaded, and the user may select the blockchain command 144 to blockchain an entry representing any previous web page 38. FIGS. 12-14 illustrate similar mechanisms for the historical social postings 44, the historical emails 34, and the historical calls 48. Exemplary embodiments thus allow the user to access historical usage and to blockchain any logged usage. The user, in other words, may go backwards in time, inspect usage logs, and ex post facto add historical usage to her personal blockchain 54. So, the user need not immediately guess or estimate what usage is worthy of blockchaining. The user, instead, may wait and see which historical text messages 30, emails 34, web pages 38, social postings 44, and other usage becomes important for blockchaining.

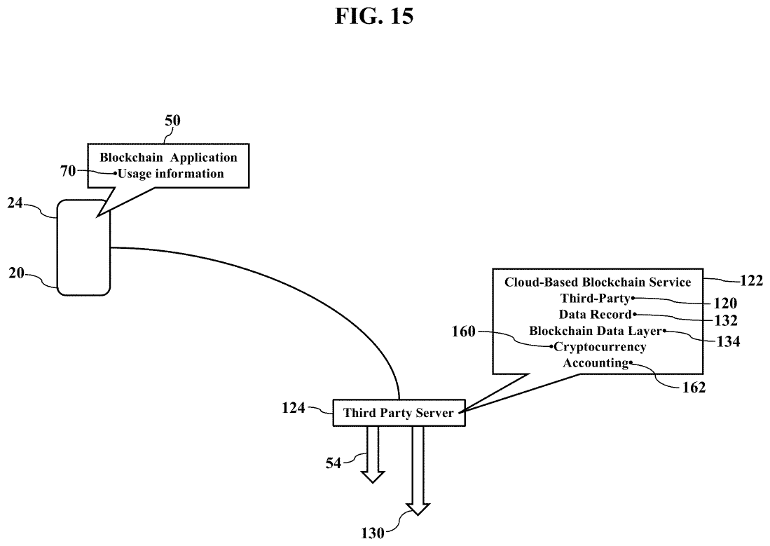

FIG. 15 illustrates a compensation scheme. When the third-party server 124 provides the cloud-based blockchain service 122, the third-party 120 may be compensated for the blockchain application 50, for generating the personal blockchain 54, for generating the data record(s) 132 in the blockchain data layer 134, and/or for generating entries in the public blockchain 130. That is, the third-party server 124 provides or executes the cloud-based blockchain service 122 in exchange for some kind of compensation. While the compensation may be a conventional currency, FIG. 15 illustrates a cryptocurrency 160. That is, the smartphone 24 and the third-party server 124 may exchange electronic tokens, coins, or other forms of the cryptocurrency 160. The cryptocurrency 160 may then be recorded as yet another transaction or block of data within the personal blockchain 54 and/or the public blockchain 130. The smartphone 24 and the third-party server 124 may thus generate an accounting 162 in response to the cloud-based blockchain service 122. Moreover, either or both of the personal blockchain 54 and/or the public blockchain 130 may also document the accounting 162.

Exemplary embodiments thus present an elegant solution. Exemplary embodiments may generate the personal blockchain 54 that documents personal usage of a single device (such as the smartphone 24). However, when the multiple devices 20 are associated with the same user (perhaps by a common user identifier, account, or authentication scheme), exemplary embodiments may additionally or alternatively create the user-specific, personal blockchain 54 that documents personal usage of all her multiple devices 20. Because some usage may be unworthy or not meaningful for blockchain documentation, exemplary embodiments may also permit selection of individual, historical usage that deserves the blockchain recordation 140. Because blockchain technology integrates or chains cryptographically hashed blocks of data, timestamps, and other data, the personal blockchain 54 may thus be an open, distributed ledger that records transactional usage for validation and distribution. Cryptographic publication provides a public witness via anchor(s) to the public blockchain 130.

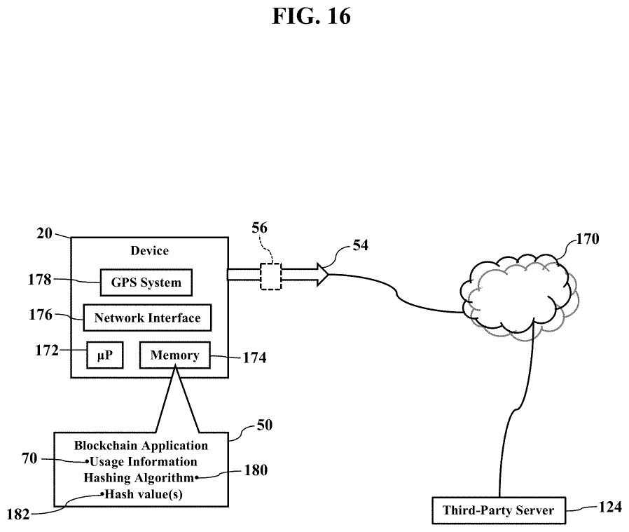

FIGS. 16-20 are more detailed illustrations of an operating environment, according to exemplary embodiments. FIG. 16 illustrates the user's device 20 communicating with the third-party server 124 via a communications network 170. The user's device 20 has a processor 172 (e.g., “μP”), application specific integrated circuit (ASIC), or other component that executes the blockchain application 50 stored in a local, solid-state memory device 174. The user's device 20 has a network interface 176 to the communications network 170, thus allowing two-way, bidirectional communication (perhaps with the third-party server 124). The blockchain application 50 includes instructions, code, and/or programs that cause the device 20 to perform operations, such as collecting the usage information 70.

FIG. 16 also illustrates the personal blockchain 54. When the user's device 20 executes the blockchain application 50, the blockchain application 50 may cause the user's device 20 to generate data records in the personal blockchain 54. The blockchain application 50 collects the usage information 70, perhaps including the date/time stamp 58 and the location 60 (explained above with reference to FIGS. 3-6). The location 60 may be global positioning system (“GPS”) information generated by an internal GPS receiver, card, or other system 178. Indeed, the GPS system 178 may also derive or generate the date/time stamp 58. Regardless, the blockchain application 50 may then call, invoke, and/or apply an electronic representation of a hashing algorithm 180 to the usage information 70. The hashing algorithm 180 thus generates one or more cryptographic hash values 182, which the blockchain application 50 may incorporate into the block(s) 56 of data within the personal blockchain 54 as a personal or private usage repository or archive for any usage of the smartphone 24.

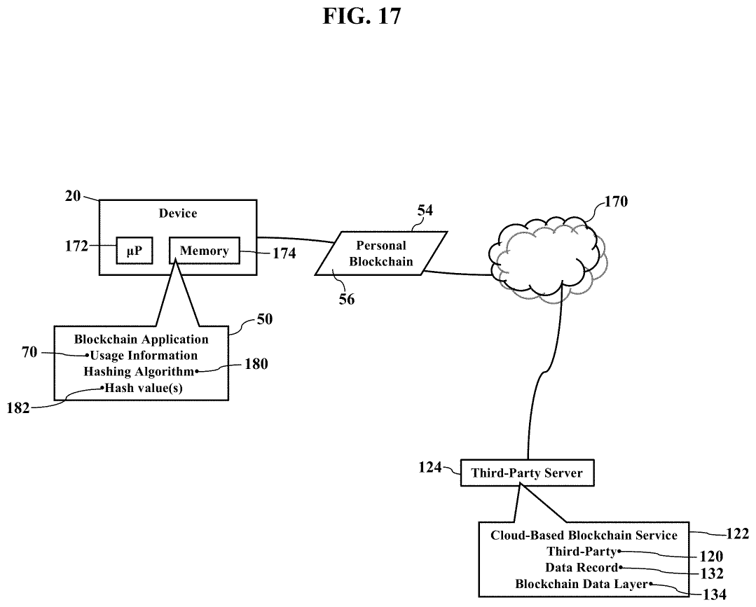

FIG. 17 illustrates the cloud-based blockchain service 122. Here the user's device 20 may send the personal blockchain 54 to the IP address associated with the third-party server 124 (via the communications network 170). When the third-party server 124 receives any of the blocks 56 of data associated with the personal blockchain 54, the third-party server 124 may provide the cloud-based blockchain service 122. The cloud-based blockchain service 122, for example, may publicly document the personal blockchain 54. The third-party server 124 may generate the one or more data records 132 within the blockchain data layer 134. The third-party server 124 may thus be called or termed a data layer server that generates the blockchain data layer 134, as later paragraphs will explain.

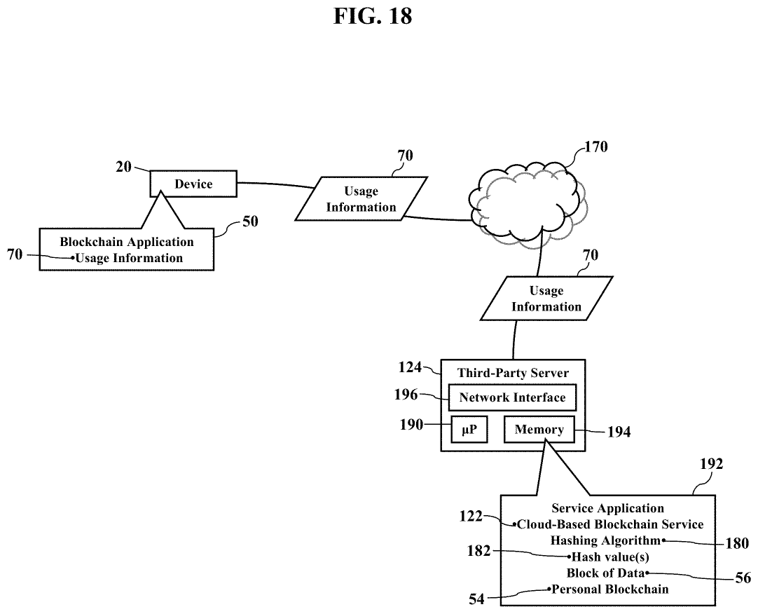

FIG. 18 also illustrates the cloud-based blockchain service 122. Here, though, exemplary embodiments may send or push the usage information 70 to the cloud-based blockchain service 122. The blockchain application 50 (executed by the user's device 20) obtains the usage information 70 and sends the usage information 70 directly to the third-party server 124. The third-party server 124 then applies the cloud-based blockchain service 122 to the usage information 70. The third-party server 124 has a processor 190 (e.g., “μP”), application specific integrated circuit (ASIC), or other component that executes a service application 192 stored in a local, solid-state memory device 194. The third-party server 124 has a network interface 196 to the communications network 170, thus allowing two-way, bidirectional communication with the user's device 20. The service application 192 includes instructions, code, and/or programs that cause the third-party server 124 to perform operations, such as retrieving the usage information 70 and calling, invoking, and/or applying an electronic representation of the hashing algorithm 180 to generate the one or more cryptographic hash values 182. The service application 192 may then incorporate the hash values 182 into the block(s) 56 of data within the personal blockchain 54 as a personal or private storage repository or archive for any usage of the smartphone 24.

The usage information 70 may be any device or network data. While the usage information 70 may be any electronic data or representation, the usage information 70 is likely binary data or values. The usage information 70 may represent names, text, biometric identification (e.g., fingerprint, Iris, and/or voice), Internet protocol address(es), domain name information, audio, video, image, web page, time, location (e.g., GPS), key or touch inputs (clickstream data), hardware serial numbers, cellular identifiers, and any other data or information describing an input or output. The usage information 70 may also include or represent any alphanumeric combination that uniquely identifies the smartphone 24, such as the smartphone's cellular telephone number (or CTN), International Mobile Subscriber Identity (or IMSI), or Mobile Station International Subscriber Directory Number (MSISDN).

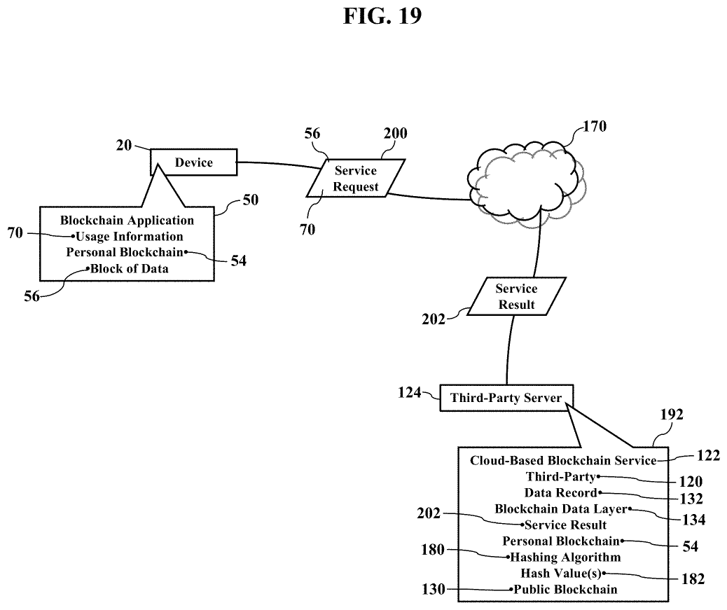

FIG. 19 illustrates a service mechanism. When the blockchain application 50 requires the cloud-based blockchain service 122, the blockchain application 50 instructs the user's device 20 to generate and send a service request 200 via the communications network 170 to the network address (such as an Internet protocol address) associated with the third-party server 124. The service request 200 may include the usage information 70 and/or any block(s) 56 of data in the personal blockchain 54. The service application 192 acts on the usage information 70 and/or any block(s) 56 of data to generate a service result 202 (such as a data record in the personal blockchain 54). The service application 192 may also create the data records 132 associated with the blockchain data layer 134. The data records 132 may comprise data or information representing the service request 200, service result 202, and/or their corresponding hash values 182. Moreover, the service application 192 may itself call, invoke, and/or apply the electronic representation of the hashing algorithm 180 to the data records 132, which may be incorporated into the public blockchain 130.

Exemplary embodiments may thus cooperate in a client/server fashion. The user's device 20 and the third-party server 124 may cooperate to send, receive, and/or generate the service request 200, the service result 202, and/or the data records 132 associated with the blockchain data layer 134. The blockchain application 50 and the service application 192 may likewise cooperate to send, receive, and/or generate the personal blockchain 54 and/or the public blockchain 130.

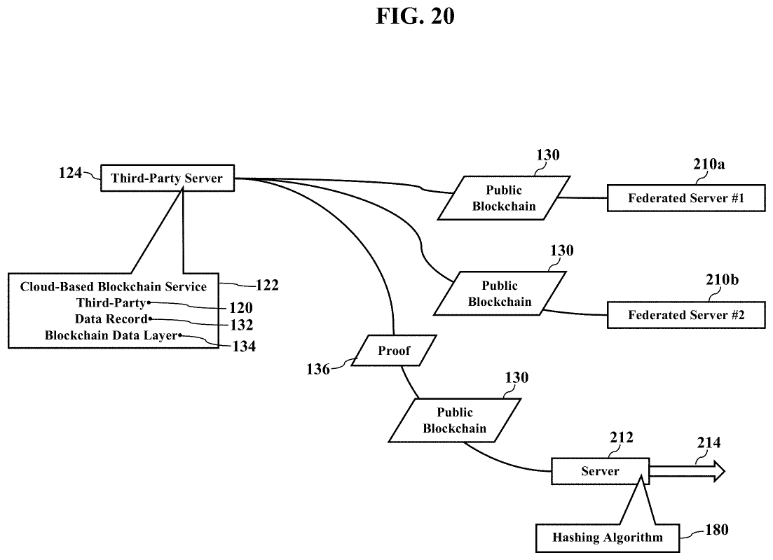

FIG. 20 illustrates additional publication mechanisms. Once the blockchain data layer 134 is generated, the blockchain data layer 134 may be published in a decentralized manner to any destination. The third-party server 124, for example, may generate and distribute the public blockchain 130 (via the communications network 170 illustrated in FIGS. 16-19) to one or more federated servers 210. While there may be many federated servers 210, for simplicity FIG. 20 only illustrates two (2) federated servers 210a and 210b. The federated servers 210a and 210b provide a service and, in return, they are compensated according to a compensation or services agreement or scheme.

Exemplary embodiments include still more publication mechanisms. For example, the cryptographic proof 136 and/or the public blockchain 130 may be sent (via the communications network 170 illustrated in FIGS. 16-19) to a server 212. The server 212 may then add another, third layer of cryptographic hashing (perhaps using the hashing algorithm 180) and generate another or second public blockchain 214. While the server 212 and/or the second public blockchain 214 may be operated by, or generated for, any entity, exemplary embodiments may integrate another cryptographic coin mechanism. That is, the server 212 and/or the second public blockchain 214 may be associated with BITCOIN®, ETHEREUM®, RIPPLE®, or other cryptographic coin mechanism. The cryptographic proof 136 and/or the second public blockchain 214 may be publicly distributed and/or documented as evidentiary validation. The cryptographic proof 136 and/or the second public blockchain 214 may thus be historically and publicly anchored for public inspection and review.

Exemplary embodiments may be applied regardless of networking environment. Exemplary embodiments may be easily adapted to stationary or mobile devices having cellular, wireless fidelity (WI-FI®, near field, and/or BLUETOOTH® capability. Exemplary embodiments may be applied to mobile devices utilizing any portion of the electromagnetic spectrum and any signaling standard (such as the IEEE 802 family of standards, GSM/CDMA/TDMA or any cellular standard, and/or the ISM band). Exemplary embodiments, however, may be applied to any processor-controlled device operating in the radio-frequency domain and/or the Internet Protocol (IP) domain. Exemplary embodiments may be applied to any processor-controlled device utilizing a distributed computing network, such as the Internet (sometimes alternatively known as the “World Wide Web”), an intranet, a local-area network (LAN), and/or a wide-area network (WAN). Exemplary embodiments may be applied to any processor-controlled device utilizing power line technologies, in which signals are communicated via electrical wiring. Indeed, exemplary embodiments may be applied regardless of physical componentry, physical configuration, or communications standard(s).

Exemplary embodiments may utilize any processing component, configuration, or system. Any processor could be multiple processors, which could include distributed processors or parallel processors in a single machine or multiple machines. The processor can be used in supporting a virtual processing environment. The processor could include a state machine, application specific integrated circuit (ASIC), programmable gate array (PGA) including a Field PGA, or state machine. When any of the processors execute instructions to perform “operations,” this could include the processor performing the operations directly and/or facilitating, directing, or cooperating with another device or component to perform the operations.

Exemplary embodiments may packetize. When any device or server communicates via the communications network 170, the device or server may collect, send, and retrieve information. The information may be formatted or generated as packets of data according to a packet protocol (such as the Internet Protocol). The packets of data contain bits or bytes of data describing the contents, or payload, of a message. A header of each packet of data may contain routing information identifying an origination address and/or a destination address.

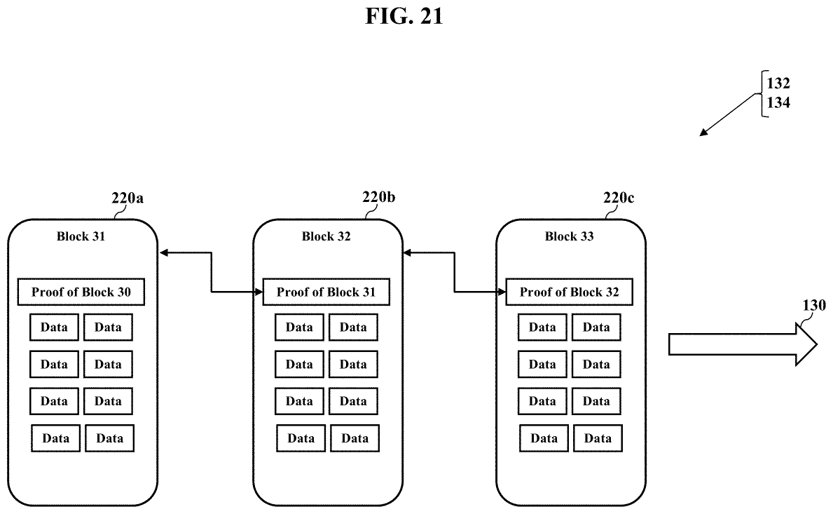

FIGS. 21-25 further illustrate the blockchain data layer 134, according to exemplary embodiments. The blockchain data layer 134 chains hashed directory blocks 220 of data into the public blockchain 130. For example, the blockchain data layer 134 accepts input data (such as the blocks 56 of data and/or the usage information 70, as explained with reference to FIGS. 8-9 and 15-18) within a window of time. While the window of time may be configurable from fractions of seconds to hours, exemplary embodiments use ten (10) minute intervals. FIG. 21 illustrates a simple example of only three (3) directory blocks 220a-c of data, but in practice there may be millions or billions of different blocks. Each directory block 220 of data is linked to the preceding blocks in front and the following or trailing blocks behind. The links are created by hashing all the data within a single directory block 220 and then publishing that hash value within the next directory block.

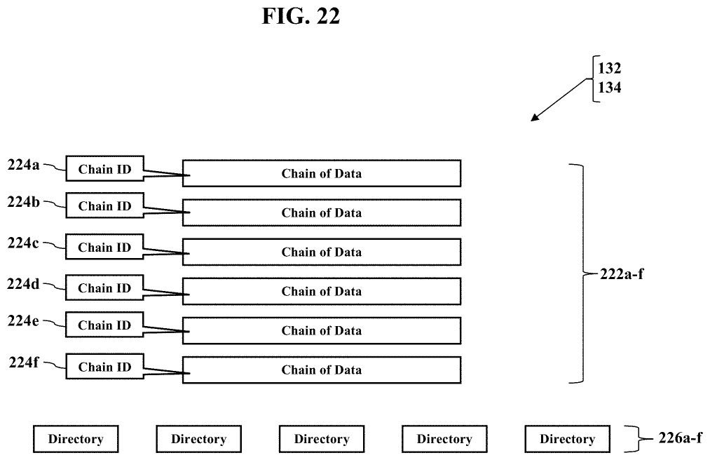

As FIG. 22 illustrates, published data may be organized within chains 222. Each chain 222 is created with an entry that associates a corresponding chain identifier 224. Each device 20 and/or each user, in other words, may have its/her corresponding chain identifier 224a-d. The blockchain data layer 134 may thus track any data associated with the entity with its corresponding chain identifier 224a-d. New and old data in time may be associated with, linked to, identified by, and/or retrieved using the chain identifier 224a-d. Each chain identifier 224a-d thus functionally resembles a directory 226a-d (e.g., files and folders) for organized data entries according to the entity.

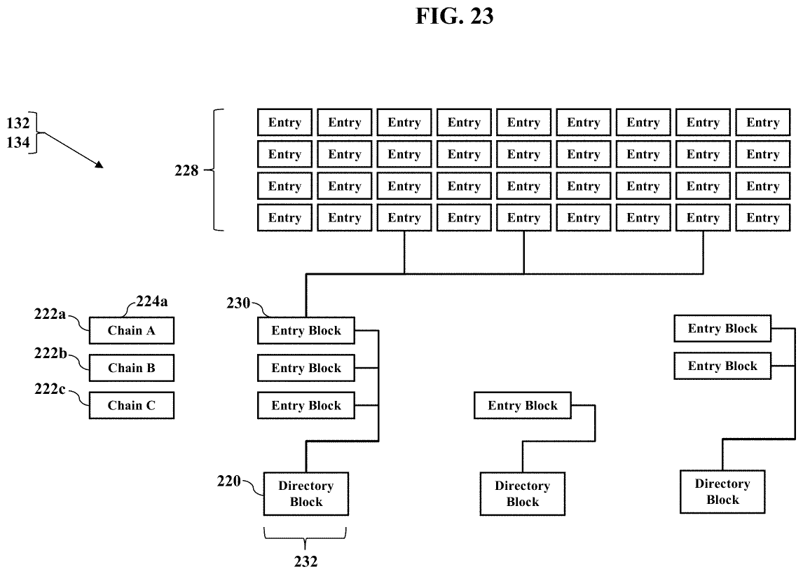

FIG. 23 illustrates the data records 132 in the blockchain data layer 134. As data is received as an input (such as the blocks 56 of data and/or the usage information 70, as explained with reference to FIGS. 8-9 and 15-18), data is recorded within the blockchain data layer 134 as an entry 228. While the data may have any size, small chunks (such as 10 KB) may be pieced together to create larger file sizes. One or more of the entries 228 may be arranged into entry blocks 230 representing each chain 222 according to the corresponding chain identifier 224. New entries for each chain 222 are added to their respective entry block 230 (again perhaps according to the corresponding chain identifier 224). After the entries 228 have been made within the proper entry blocks 230, all the entry blocks 230 are then placed within in the directory block 220 generated within or occurring within a window 232 of time. While the window 232 of time may be chosen within any range from seconds to hours, exemplary embodiments may use ten (10) minute intervals. That is, all the entry blocks 230 generated every ten minutes are placed within in the directory block 220.

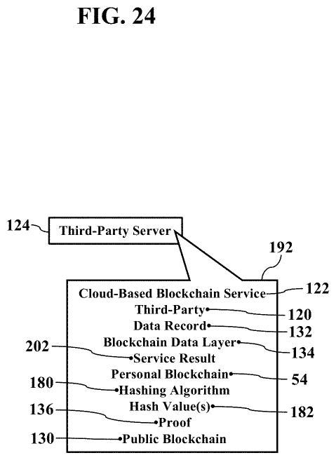

FIG. 24 illustrates cryptographic hashing. The third-party server 124 executes the service application 192 to generate the data records 132 in the blockchain data layer 134. The service application 192 may then instruct or cause the third-party server 124 to execute the hashing algorithm 180 on the data records 132 (such as the directory block 220 explained with reference to FIGS. 21-23). The hashing algorithm 180 thus generates one or more hash values 182 as a result, and the hash values 182 represent the hashed data records 132. As one example, the blockchain data layer 134 may apply a Merkle tree analysis to generate a Merkle root (representing a Merkle proof 136) representing each directory block 220. The third-party server 124 may then publish the Merkle proof 136 (as this disclosure explains).

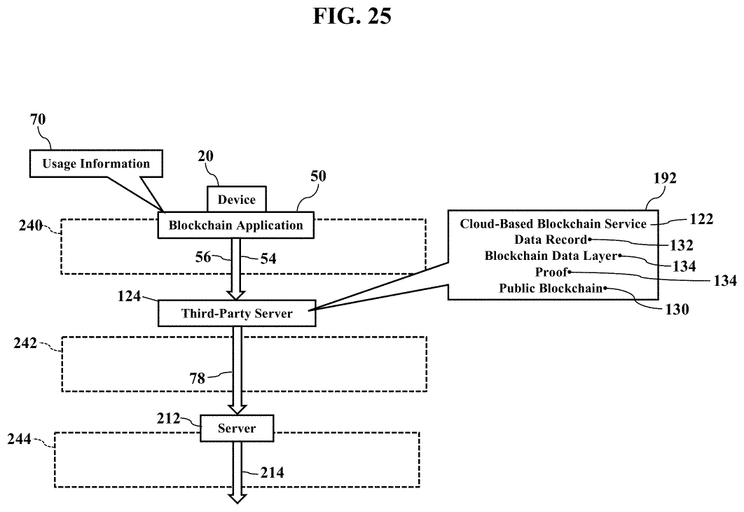

FIG. 25 illustrates hierarchical hashing. The blockchain application 50 may hash the usage information 70 to provide a first layer 240 of cryptographic hashing and then generates the personal blockchain 54. Any blocks 56 of data within the personal blockchain 54 may be sent to a destination associated with the cloud-based blockchain service 122 (such as the third-party server 124). The third-party server 124 may thus execute the service application 192 to generate the data records 132 in the blockchain data layer 134. The third-party server 124 may optionally provide a second or intermediate layer 242 of cryptographic hashing to generate the cryptographic proof 136. The service application 192 may also publish any of the data records 132 as the public blockchain 130, and the cryptographic proof 136 may or may not also be published via the public blockchain 130. The public blockchain 130 and/or the cryptographic proof 136 may be optionally sent to the server 212 as an input to yet another public blockchain 214 (again, such as BITCOIN®, ETHEREUM®, or RIPPLE®) for a third layer 244 of cryptographic hashing and public publication. The first layer 240 and the second layer 242 thus ride or sit atop a conventional public blockchain 214 (again, such as BITCOIN®, ETHEREUM®, or RIPPLE®) and provide additional public and/or private cryptographic proofs.

Exemplary embodiments may use any hashing function. Many readers may be familiar with the SHA-256 hashing algorithm. The SHA-256 hashing algorithm acts on any electronic data or information to generate a 256-bit hash value as a cryptographic key. The key is thus a unique digital signature. There are many hashing algorithms, though, and exemplary embodiments may be adapted to any hashing algorithm.

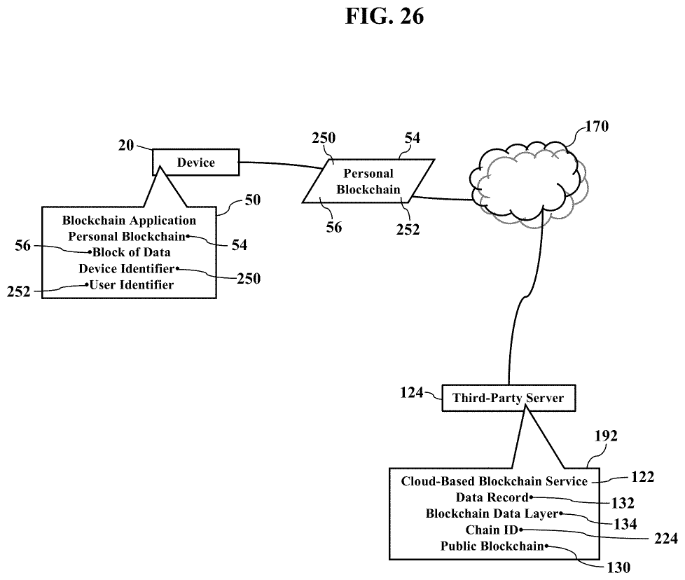

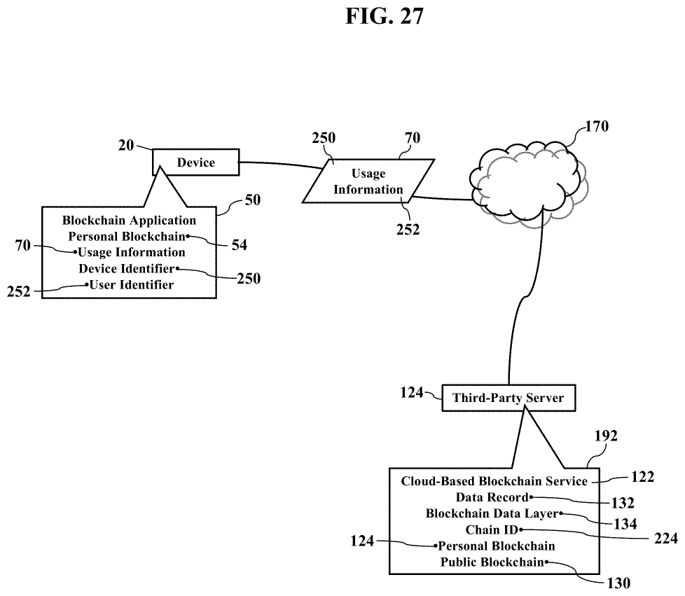

FIGS. 26-27 illustrate identifier mechanisms, according to exemplary embodiments. This disclosure already explained how each of the user's devices 20 may generate and send its device-specific, personal blockchain 54 to the third-party server 124 for the cloud-based blockchain service 122 (e.g., creation of the blockchain data layer 134, as explained with reference to FIGS. 7-8). When any device 20 sends its respective blocks 56 of data in the device-specific personal blockchain 54, each device 20 may further identify itself. That is, the block 56 of data may include, contain, specify, or reference a corresponding device identifier 250. The device identifier 250 is any data or information that uniquely identifies the device 20 sending the block 56 of data. While the device identifier 250 may be any bit/binary value representing an alphanumeric combination, most readers are perhaps familiar with a cellular telephone number assigned to the device 20 by a cellular service provider. The device identifier 250, however, may additionally or alternatively include an IP address, hardware serial number, International Mobile Subscriber Identity (or IMSI), or Mobile Station International Subscriber Directory Number (MSISDN). Whatever the device identifier 250, exemplary embodiments may provide the device identifier 250 with any data, information, or packets of data (e.g., header or body) sent to the third-party server 124. As the third-party server 124 provides the cloud-based blockchain service 122 (such as generating the data records 132 in the blockchain data layer 134), exemplary embodiments may carry or notate the data records 132 with the device identifier 250. The device identifier 250, in other words, may be used to cross-reference or annotate the data records 132 with the chain identifier 224. Exemplary embodiments may thus generate and archive the data records 132 that correspond to each of the user's devices 20. Should exemplary embodiments then hash and incorporate the data records 132 into the public blockchain 130, the public blockchain 130 may also reference or associate with device identifier 250.

Exemplary embodiments may also assign a user identifier 252. Because the user may have multiple, different devices (as explained with reference to FIGS. 7-8), each one of the devices 20 may be commonly associated with a user account or user identifier 252. That is, even though each different device 20 may send its unique device identifier 250, the device 20 may also send the common user account or user identifier 252. The user account or user identifier 252, in other words, may be sent to accompany, or included within, the block 56 of data as any data, information, or packets of data (e.g., header or body) sent to the third-party server 124. While the user account or user identifier 252 may be any bit/binary value representing an alphanumeric combination, most readers are perhaps familiar with a username, password, email address, or login credential. Whatever the identifier 252, exemplary embodiments may provide the identifier 252 to the third-party server 124. As the third-party server 124 provides the cloud-based blockchain service 122 (such as generating the data records 132 in the blockchain data layer 134), exemplary embodiments may carry or notate the data records 132 with the user account or user identifier 252. The identifier 252, in other words, may be used to cross-reference or annotate the data records 132 with the chain identifier 224. Exemplary embodiments may thus generate and archive the data records 132 that correspond to the user (as represented by her user account or user identifier 252). Again, should exemplary embodiments then hash and incorporate the data records 132 into the public blockchain 130, the public blockchain 130 may also reference or associate her user account or user identifier 252.

FIG. 27 illustrates the usage information 70. This disclosure above explained how exemplary embodiments may send or push the usage information 70 to the to the third-party server 124 for the cloud-based blockchain service 122 (e.g., creation of the blockchain data layer 134, as explained with reference to FIG. 9). When any device 20 sends its respective usage information 70, each device 20 may also identify itself using its corresponding device identifier 250. Moreover, exemplary embodiments may also identify the user account or user identifier 252. As the third-party server 124 provides the cloud-based blockchain service 122 (such as generating the data records 132 in the blockchain data layer 134), exemplary embodiments may carry or notate the data records 132 with the device identifier 250 and/or the user account or user identifier 252. The device identifier 250, in other words, may be used to cross-reference or annotate the data records 132 with the chain identifier 224. Exemplary embodiments may thus generate and archive the data records 132 that correspond to each user and her devices 20. Should exemplary embodiments then hash and incorporate the data records 132 into the personal blockchain 124 and/or the public blockchain 130, each blockchain 124 and 130 may also reference or associate the specific user and/or her specific device 20.

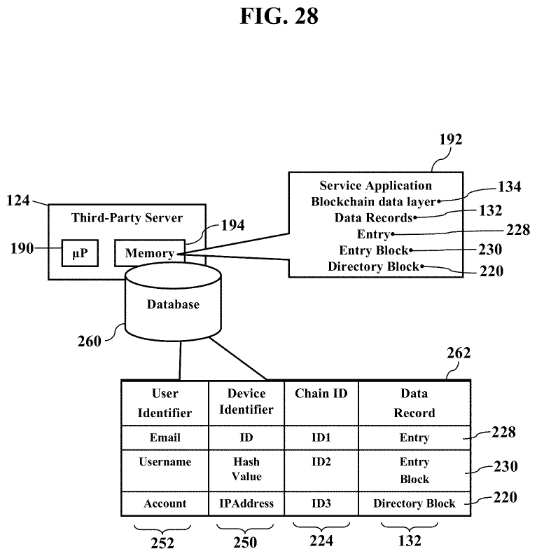

FIG. 28 further illustrates the blockchain data layer 134, according to exemplary embodiments. As this disclosure previously explained, exemplary embodiments may generate the data records 132 representing the blockchain data layer 134 (such as the entries 228, entry blocks 230, and/or the directory blocks 220 explained with reference to FIGS. 21-23). This disclosure also explained how the data records 132 may reference, incorporate, or integrate the device identifier 250 and/or the user account or user identifier 252. As any data record 132 is generated, exemplary embodiments may archive the data record 132 in an electronic database 260. The electronic database 260 may thus define entries that identify the data records 132 and their corresponding user account or user identifier 252, the device identifier 250, and/or the chain identifier 224. While the electronic database 260 may have any logical structure, FIG. 28 illustrates the database 260 as a table 262 that maps, converts, or translates each data record 132 to its corresponding user account or user identifier 252, the device identifier 250, and/or the chain identifier 224. Once any entry is known, exemplary embodiments may then query for that entry to identify its corresponding entry. Exemplary embodiments may thus a database lookup operation to identify and even retrieve related entries. The electronic database 260 may thus function or serve as a historical repository or archive that documents the blockchain data layer 134 according to the user and her multiple devices 20.

Exemplary embodiments represent a personal archive. As any data record 132 is generated, exemplary embodiments may reference the data record 132 in the electronic database 260. The cloud-based blockchain service 122 may thus also function as a query handler to receive queries from clients. A query may specify any query parameter and the cloud-based blockchain service 122 looks up and/or retrieves the corresponding entries. For example, a client submitting a query may specify the device identifier 250, and the cloud-based blockchain service 122 generates a query response that identifies all the data records 132 that are associated with the device identifier 250. If the query parameter specifies the user account or user identifier 252, then the cloud-based blockchain service 122 may identify all the data records 132 that are associated with the same user. Indeed, because the data records 132 may also be cataloged or logged according to time (such as the window 232 of time illustrated with reference to FIG. 23), the query parameter may further specify an interval of time to further narrow the search results. Regardless, the data records 132 may be quickly searched and retrieved to provide immutable evidence of usage.

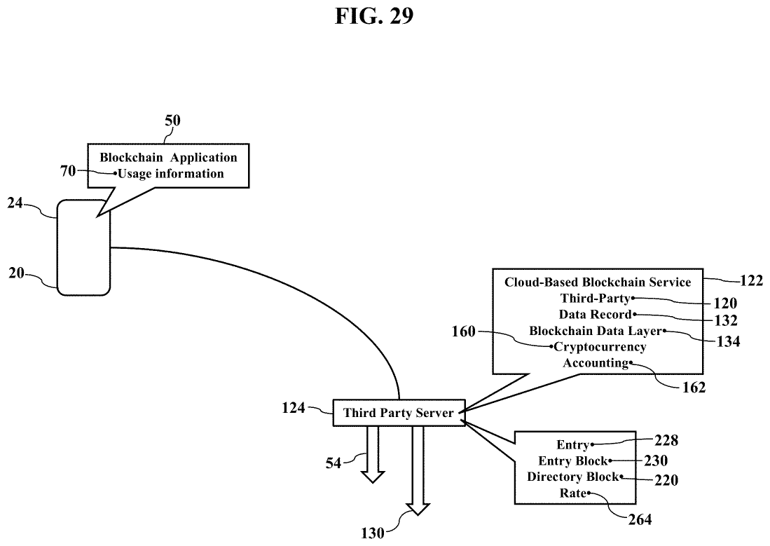

FIG. 29 further illustrates the cryptocurrency 160, according to exemplary embodiments. As this disclosure above explained, when the third-party server 124 provides the cloud-based blockchain service 122, the third-party 120 may be compensated. While the compensation may be a conventional currency, FIG. 29 illustrates the cryptocurrency 160. Here, though, the accounting 162 may be based on the data records 132 generated in the blockchain data layer 134. That is, exemplary embodiments may process a cryptographic fee based on the entries 228, entry blocks 230, and/or the directory blocks 220 generated within the blockchain data layer 134. That is, as the data records 132 are generated, exemplary embodiments may sum or count the entries 228, entry blocks 230, and/or the directory blocks 220 that are generated over time (such as per second, per minute, or other interval). The cloud-based blockchain service 122, for example, calls or initializes a counter having an initial value (such as zero). At an initial time, the counter commences or starts counting or summing the number of the entries 228, entry blocks 230, and/or the directory blocks 220 (generated within the blockchain data layer 134) that are commonly associated with or reference the same user account or user identifier 252, the same device identifier 250, and/or the same chain identifier 224. The counter stops counting or incrementing at a final time and/or when no more data records 132 are generated. Regardless, exemplary embodiments determine or read the final value or count. Exemplary embodiments may then sum or tally a total number of the data records 132 that were generated and perhaps even a rate 264 of generation (e.g., the sum or count over time). The accounting 162 may thus process a cryptofee based on the total number of the data records 132 and/or the rate 264 of generation within the blockchain data layer 134.

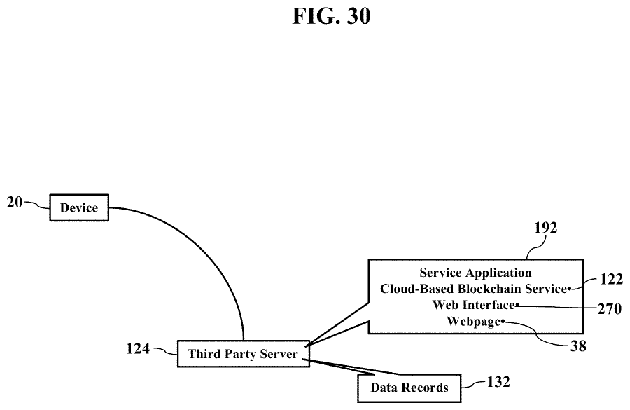

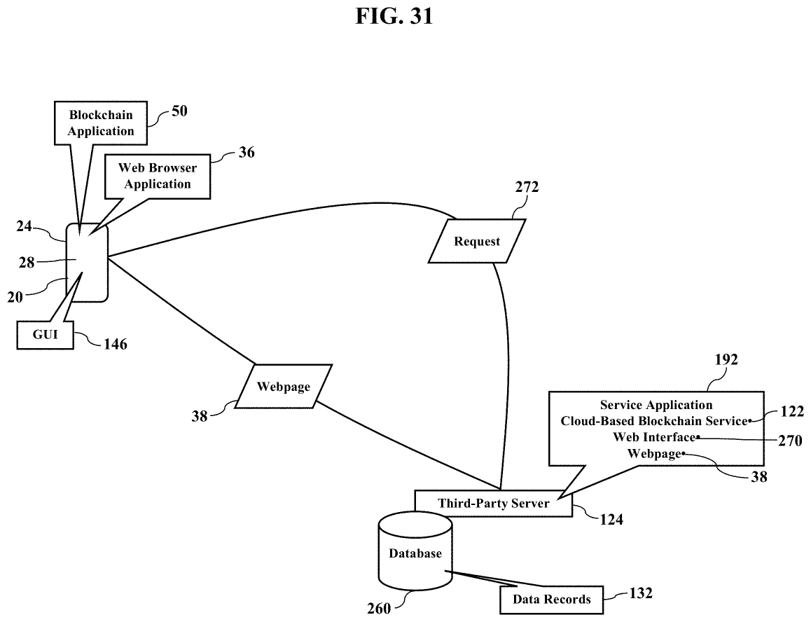

FIGS. 30-31 illustrate web access, according to exemplary embodiments. Here exemplary embodiments may be accessed and configured via the communications network 170 (such as the Internet, as illustrated with reference to FIGS. 16-19). FIG. 30 thus illustrates the service application 192 as a software-as-a-service offered by the third-party server 124. A user, in other words, may access the service application 192 to define the various parameters governing the cloud-based blockchain service 122. While exemplary embodiments may have any access mechanism, FIG. 30 illustrates a web interface 270. That is, the service application 192 may be accessed via the webpage 38. The webpage 38 prompts the user's device 20 to input or to select one or more parameters governing the cloud-based blockchain service 122.

FIG. 31 further illustrates the web interface 270. Again, as most readers are thought familiar with mobile computing, FIG. 31 again illustrates the user's smartphone 24 executing the blockchain application 50 and the web browser application 36. If the smartphone 24 correctly sends authentication credentials, then the smartphone 24 may utilize the web interface 270 to access the cloud-based blockchain service 122. The smartphone 24 executes the web browser application 36 to send a request 272 specifying an address or domain name associated with or representing the cloud-based blockchain service 122 and/or the third-party server 124. The web interface 270 to the third-party server 124 thus sends the webpage 38 as a response, and the user's smartphone 24 downloads the webpage 38. The blockchain application 50 and/or the web browser application 36 instructs the smartphone 24 to display the webpage 38 as the graphical user interface (or “GUI”) 146 on its display device 28. The GUI 146 may generate one or more prompts or fields for specifying the parameters defining the cloud-based blockchain service 122. As one example, the webpage 38 may have prompts or fields for specifying a query parameter for searching the database 260 for historical data records 132.

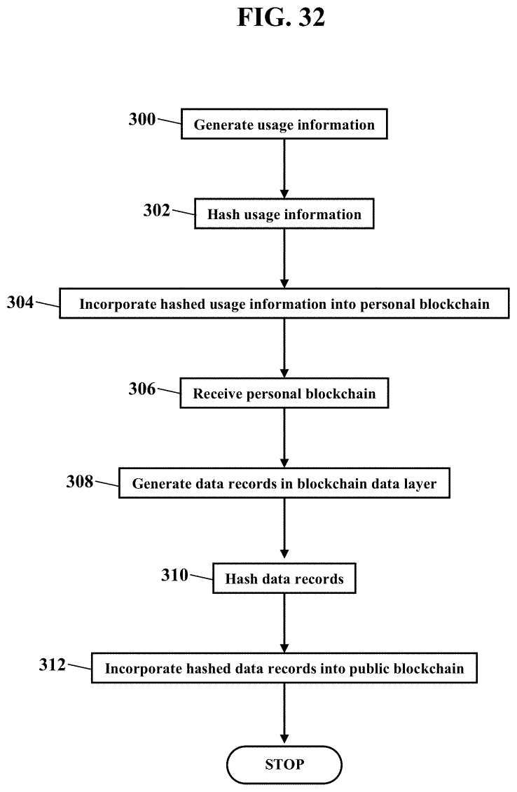

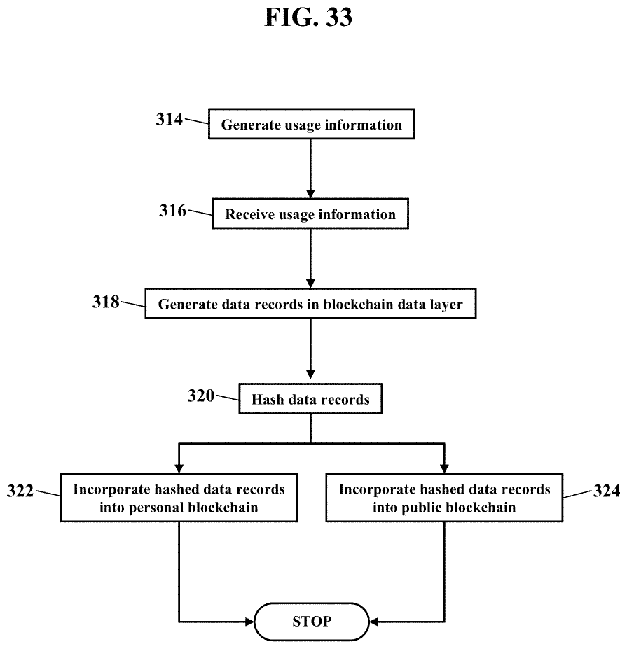

FIGS. 32-33 are flowcharts illustrating a method or algorithm for service processing, according to exemplary embodiments. The usage information 70 is generated (Block 300), hashed (Block 302), and incorporated into the personal blockchain 54 (Block 304). The personal blockchain 54 is received by the third-party server 124 (Block 306) and the data records 132 in the blockchain data layer 134 are generated (Block 308). The data records 132 in the blockchain data layer 134 may be hashed (Block 310) and incorporated into the public blockchain 130 (Block 312).

In FIG. 33, the usage information 70 is generated (Block 314) and sent to the third-party server 124 (Block 316). The data records 132 in the blockchain data layer 134 are generated (Block 318). The data records 132 may be hashed (Block 320) and incorporated into the personal blockchain 54 (Block 322) and/or the public blockchain 130 (Block 324).

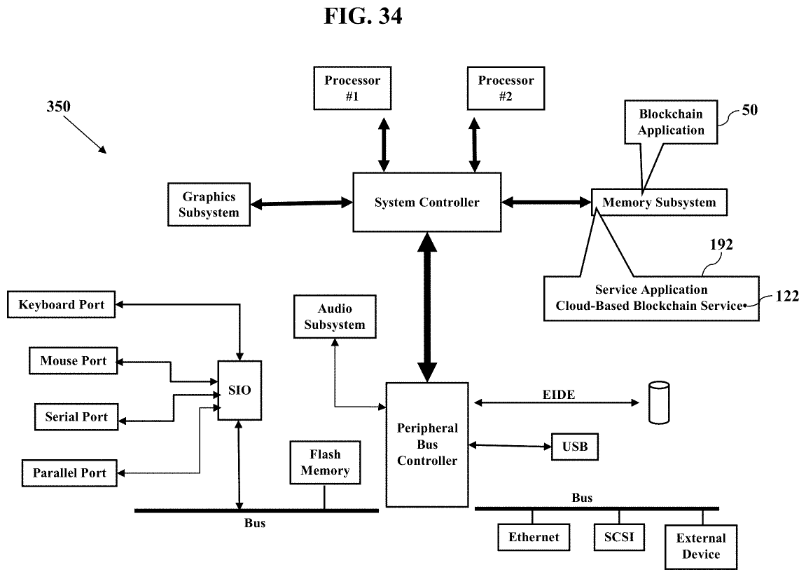

FIG. 34 is a schematic illustrating still more exemplary embodiments. FIG. 34 is a more detailed diagram illustrating a processor-controlled device 350. As earlier paragraphs explained, the blockchain application 50 and/or the service application 192 may partially or entirely operate in any mobile or stationary processor-controlled device. FIG. 34, then, illustrates the blockchain application 50 and/or the service application 192 stored in a memory subsystem of the processor-controlled device 350. One or more processors communicate with the memory subsystem and execute either, some, or all applications. Because the processor-controlled device 350 is well known to those of ordinary skill in the art, no further explanation is needed.

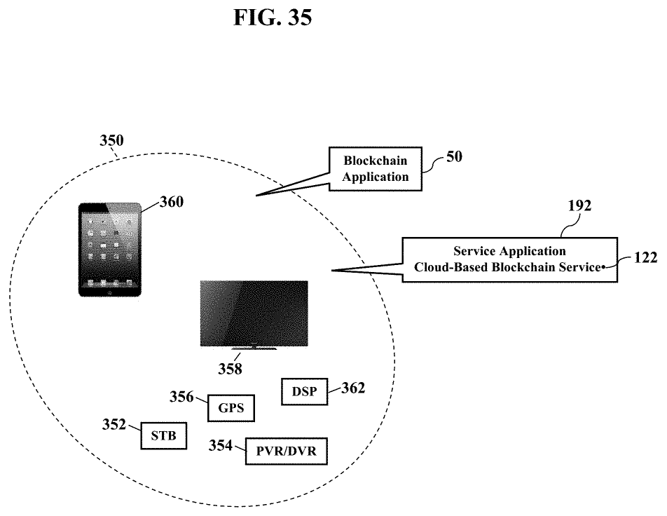

FIG. 35 depicts other possible operating environments for additional aspects of the exemplary embodiments. FIG. 35 illustrates the blockchain application 50 and/or the service application 192 operating within various other processor-controlled devices 350. FIG. 35, for example, illustrates that the blockchain application 50 and/or the service application 192 may entirely or partially operate within a set-top box (“STB”) (352), a personal/digital video recorder (PVR/DVR) 354, a Global Positioning System (GPS) device 356, an interactive television 358, a tablet computer 360, or any computer system, communications device, or processor-controlled device utilizing any of the processors above described and/or a digital signal processor (DP/DSP) 362. Moreover, the processor-controlled device 350 may also include wearable devices (such as watches), radios, vehicle electronics, clocks, printers, gateways, mobile/implantable medical devices, and other apparatuses and systems. Because the architecture and operating principles of the various devices 350 are well known, the hardware and software componentry of the various devices 350 are not further shown and described.

Exemplary embodiments may be applied to any signaling standard. Most readers are thought familiar with the Global System for Mobile (GSM) communications signaling standard. Those of ordinary skill in the art, however, also recognize that exemplary embodiments are equally applicable to any communications device utilizing the Time Division Multiple Access signaling standard, the Code Division Multiple Access signaling standard, the “dual-mode” GSM-ANSI Interoperability Team (GAIT) signaling standard, or any variant of the GSM/CDMA/TDMA signaling standard. Exemplary embodiments may also be applied to other standards, such as the I.E.E.E. 802 family of standards, the Industrial, Scientific, and Medical band of the electromagnetic spectrum, BLUETOOTH®, and any other.

Exemplary embodiments may be physically embodied on or in a computer-readable non-transitory storage medium. This computer-readable medium, for example, may include CD-ROM, DVD, tape, cassette, floppy disk, optical disk, memory card, memory drive, and large-capacity disks. This computer-readable medium, or media, could be distributed to end-subscribers, licensees, and assignees. A computer program product comprises processor-executable instructions for service processing in blockchain environments, as the above paragraphs explain.

While the exemplary embodiments have been described with respect to various features, aspects, and embodiments, those skilled and unskilled in the art will recognize the exemplary embodiments are not so limited. Other variations, modifications, and alternative embodiments may be made without departing from the spirit and scope of the exemplary embodiments.

1. A method, comprising:
receiving, by a device, a selection of an electronic message for a blockchain recordation;
querying, by the device, an electronic database for the electronic message selected for the blockchain recordation, the electronic database associating usage information to historical electronic messages sent and received by the device;
identifying, by the device; the usage information in the electronic database that is associated with the electronic message selected for the blockchain recordation;
hashing, by the device, the usage information using an electronic representation of a hashing algorithm to generate a hash value representing the usage information; and
incorporating, by the device, the hash value representing the usage information into a block of data within a blockchain;
wherein the electronic message selected for the blockchain recordation is represented by the hash value incorporated into the block of data within the blockchain.

2. The method of claim 1, further comprising receiving a listing of the historical electronic messages sent from and received by the device.

3. The method of claim 1, further comprising touch screen data that corresponds to the selection of the electronic message for the blockchain recordation.

4. The method of claim 1, further comprising touch screen data that corresponds to a graphical control representing the blockchain recordation.

5. The method of claim 1, further comprising generating a graphical control representing the blockchain recordation.

6. The method of claim 1, further comprising associating the block of data to a device identifier that uniquely identifies the device.

7. The method of claim 1, further comprising associating the block of data to a user identifier that uniquely identifies a user associated with the device.

8. A system, comprising:
a hardware processor; and
a memory device, the memory device storing instructions, the instructions when executed causing the hardware processor to perform operations, the operations comprising:
receiving a selection of an electronic message for a blockchain recordation;
querying an electronic database for the electronic message selected for the blockchain recordation, the electronic database associating usage information to historical electronic messages sent from and received by the device;
identifying the usage information in the electronic database that is associated with the electronic message selected for the blockchain recordation;
hashing the usage information using an electronic representation of a hashing algorithm to generate a hash value representing the usage information;
incorporating the hash value representing the usage information into a block of data within a personal blockchain; and
sending the block of data to a cloud-based blockchain service that generates a data record in a blockchain data layer;
wherein the cloud-based blockchain service represents the electronic message selected for the blockchain recordation by the data record in the blockchain data layer.

9. The system of claim 8, wherein the operations further comprise receiving a service request for the cloud-based blockchain service.

10. The system of claim 8, wherein the operations further comprise associating the cloud-based blockchain service to a device identifier that uniquely identifies the system.

11. The system of claim 8, wherein the operations further comprise associating the cloud-based blockchain service to a user identifier that uniquely identifies a user.

12. The system of claim 8, wherein the operations further comprise associating the data record in the blockchain data layer to a device identifier that uniquely identifies the system.

13. The system of claim 8, wherein the operations further comprise associating the data record in the blockchain data layer to a user identifier that uniquely identifies a user.

14. The system of claim 8, wherein the operations further comprise transacting a cryptocoinage in response to the cloud-based blockchain service.

15. The system of claim 8, wherein the operations further comprise generating a cryptographic proof based on the cloud-based blockchain service.

16. The system of claim 15, wherein the operations further comprise integrating the cryptographic proof in a public blockchain to document the cloud-based blockchain service.

17. A memory device storing instructions that when executed cause a hardware processor to perform operations, the operations comprising:
receiving a selection of an electronic message for a blockchain recordation;
querying an electronic database for the electronic message selected for the blockchain recordation, the electronic database associating usage information to historical electronic messages sent from and received by the device;
identifying the usage information in the electronic database that is associated with the electronic message selected for the blockchain recordation;
hashing the usage information using an electronic representation of a hashing algorithm to generate a hash value representing the usage information;
incorporating the hash value representing the usage information into a block of data within a personal blockchain; and
sending the block of data to a cloud-based blockchain service that generates a data record in a blockchain data layer;
wherein the cloud-based blockchain service represents the electronic message selected for the blockchain recordation by the data record in the blockchain data layer.

18. The memory device of claim 15, wherein the operations further comprise transacting a cryptocoinage in response to the cloud-based blockchain service.

19. The memory device of claim 15, wherein the operations further comprise generating a cryptographic proof based on the cloud-based blockchain service.

20. The memory device of claim 15, wherein the operations further comprise integrating the cryptographic proof in a public blockchain to document the cloud-based blockchain service.
